(19) United States
(12) Patent Application Publication
(10) Pub. No.: US 2021/0211417 A1
(43) Pub. Date: Jul. 8, 2021

(54) Methods and systems to automatically interconnect devices and applications over multi-cloud providers and on-premises networks

(71) Applicant: Nicolas Souty, Laval (CA)

(72) Inventor: Nicolas Souty, Laval (CA)

(21) Appl. No.: 16/736,344

(22) Filed: Jan. 7, 2020

(51) Int. Cl. H04L 29/06; H04L 12/24

(52) U.S. Cl. CPC H04L 63/0807; H04L 41/0886; H04L 41/026

(57) ABSTRACT

A system and method to automatically interconnect data communications over multicloud providers and on-premises networks, using an open, publicly accessible registry service, is disclosed. Components (e.g., network devices, servers, applications, IoT devices, etc.) contact the open registry service to offer potential connectivity to themselves and request inter-connect information in secured manner. In response, the open registry service returns the list of peer components to connect with, along with other parameters. The requesting component can then initiate connection(s) to the peer component(s).

### BACKGROUND

The invention relates to service management and data communications across multi-clouds and private networks, in particular, it relates to a method to discover and maintain inter-connects between parties so that they can exchange data easily and securely.

The present invention is based on the trend that applications and services are more and more deployed over multi-clouds and on-premises environments. With this, come multiple challenges in terms of complexity, connectivity, security and increased costs.

More specifically, organizations require an automatic way to dynamically connect components no matter where they are located and update those connections as the environment changes. On top of this, scalability, security, and multi-tenancy must be addressed.

In response, organizations try different approaches, from implementing traditional middlewares, building customized connectors or bridges, or internally develop their own proprietary solution.

None of the aforementioned approaches achieve the required capabilities in an easy and cost-effective way.

Consequently, there is a clear need for improvements, for a system capable of providing individually registered software components their inter-connecting parameters.

### SUMMARY

The present invention addresses the problem of discovering, creating and maintaining inter-connect configurations between several components, no matter where located, and this, done in an automatic, secure and cost-effective manner.

The invention is a worldwide registry service, for computers, applications, or other resources capable of reaching the Internet. By providing a publicly accessible, cloud-based registry service, the invention is an essential component to facilitate discovery and control of distributed applications and services, even if they span across multiples cloud providers and private networks. In some embodiments, the registry service can be hosted on a private network assuming any components to be interconnected can reach it.

More specifically, the said service informs any resources with inter-connectivity information, so they can communicate together, without the need for an administrator or a user to manually configure it.

This is achieved through a central registry service receiving ping requests from each component. This central registry service is composed of a registry server and a registry repository. The registry server stores and maintains information for each registered component in its registry repository. Such information includes—but is not limited to—component attributes, status, supported communication protocols, supported versions, minimum security requirements and also component statistics. The registry repository is updated in near real-time with the ping requests coming from these remote components; it may also be updated with parameters coming from the configuration owner of that component.

In response to a ping request, the registry server sends to the requesting resource a list of peers that the requesting component should communicate with, by indicating which are their roles, protocol, security credentials, and other important connectivity details, to create a network of data communication.

An advantage of the present invention is that the centralized registry service permits global inter-connectivity. Every resource, no matter where located, can reach the central registry service. The registry service, combined with a light protocol enables inter-connectivity to be optimally realized, and in consequence greatly reduces the complexity and cost for discovering, creating and maintaining secured distributed services.

Another advantage of the present invention is that the protocol may apply to the different type of devices, applications, domains from today's IT and beyond.

A further advantage of the present invention is that the registry service is aware in near real-time of the state of every registered component and the health of all active components. This health data can be made available to higher applications, such as a monitoring solution. This monitoring data may also permit the registry service to determine and update the inter-connection decision on the less stressed resources, if available, to ensure the best quality-of-service and increase the service reliability. This re-routing decision may be taken using simple policies such as thresholds or more sophisticated policies based on historical analysis, forecasting and business logic.

Another advantage of the present invention is that the protocol is extensible, and allows components to send various information encapsulated within the ping request, said information may be, but not limited to, system and protocol versions, logs, events, etc. This information can be made available to higher applications, such as log/event management systems, configuration management systems, etc.

A yet further advantage of the present invention is to ensure a high level of security. The registry service knows the security requirement for every component and then can initiate the trust between these without requiring additional services. Furthermore, all the communications between the components and the registry service are protected by a combination of encryption and digital signatures.

Still another advantage of the present invention is that the registry service maintains interconnections when components moves their location from a network to another. In one embodiment, the component can move from an on-premises location to a cloud location. In another embodiment, the component can move from a cloud location to another cloud or on-premises location. Other movement scenarios may be considered and the interconnection will still be discovered and maintained.

Further details of aspects, objectives, and advantages of the present invention are described in the detailed descriptions and drawings. Both the foregoing general description of the background and the following detailed description are exemplary and explanatory and are not intended to be limiting as to the scope of the present invention.

### BRIEF DESCRIPTION OF THE DRAWINGS

FIG. 1a is a block diagram illustrating a first exemplary embodiment of the present invention, where all the components participating to the inter-connect method are located in the cloud.

FIG. 1b is a block diagram illustrating another embodiment of the present invention, where the components participating to the inter-connect method are located either in the cloud or on-premises.

FIG. 1c is a block diagram illustrating another exemplary embodiment of the present invention, where all the components participating to the inter-connect method are located on-premises.

FIG. 2 is a block diagram representing the registry service used in the present invention.

FIG. 3 illustrates the registry repository.

FIG. 4 is a message flow sequence and steps for discovering, creating and maintaining pairing during the lifecycle, in accordance with embodiments of the present invention.

FIG. 5a illustrates a ping request message.

FIG. 5b illustrates a ping response message

### DETAILED DESCRIPTION

Reference is now made to the drawings wherein like numerals refer to like parts throughout.

As used herein, the terms “location” generally refers to any data center including, without limitation, private customer network, public clouds, and private clouds or even a personal home or a mobile communication device.

As used herein, the term “Ping” means a short and encrypted message transaction sent over IP network by the registering components to the registry service. We will use the term “Ping Request” to talk about the message initiated by the component to the central registry server, and we will use the terms “Ping Response” to specify the content provided by the registry service to that component. Both, the request and the answer are part of a single TCP transaction initiated always from the registering component.

As used herein, the terms “software components”, “entities”, “nodes” and “components” include, but are not limited to an application running on a computer in a home or datacenter, a software part of a distributed application running on multi nodes (multi servers, multi dockers or containers, etc.), a software component inside an IoT module (such as a thermostat, a solar panel controller, a home battery, a home electrical panel, etc.), a software running on a phone or other mobile devices, a software module built-in a car, or literally any other device capable of interchanging data with a network. These software components can be over disparate networks.

### Overview

An embodiment of the invention is discussed in detail below. While specific implementations are discussed, this is done for illustration purposes only. A person skilled in the relevant art will recognize that other components and configurations may be used without departing from the spirit and scope of the invention.

In accordance with the present invention, the interconnect data is supported through an open and publicly accessible registry service. This service provides connectivity information to entities and does not require those entities to invest heavily in specialized software or resources. Only a light communication layer, the protocol, is required to communicate with the central registry service. As will be described in greater details below, the present invention enables communications over a lifecycle. This service facilitates connectivity to the organizations that run complex distributed applications (i.e., large enterprises, Managed Service Providers, Telecommunication Providers, etc.) but more generally, the service can be used by any organization and for any domain or purpose.

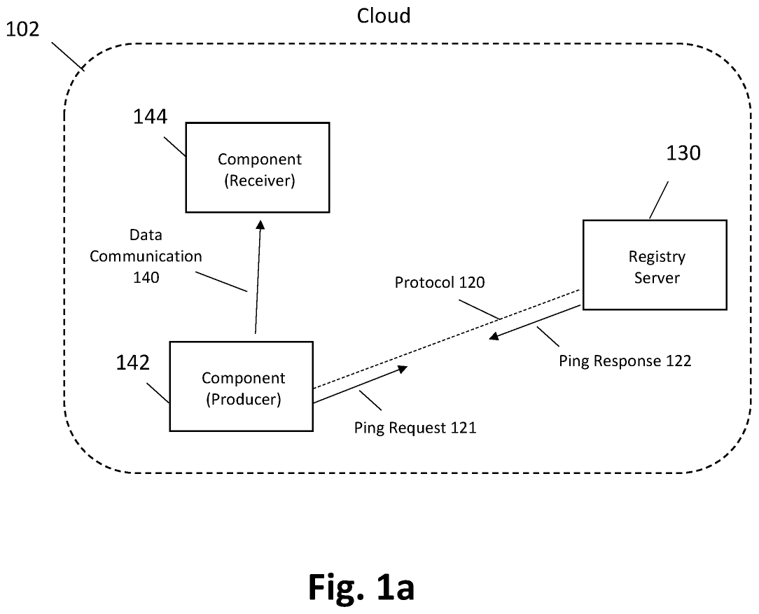

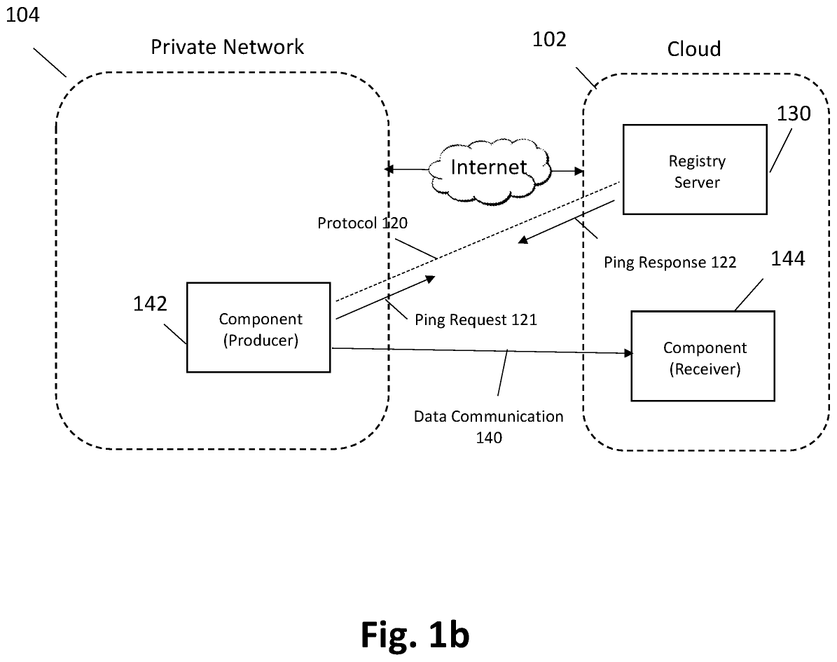

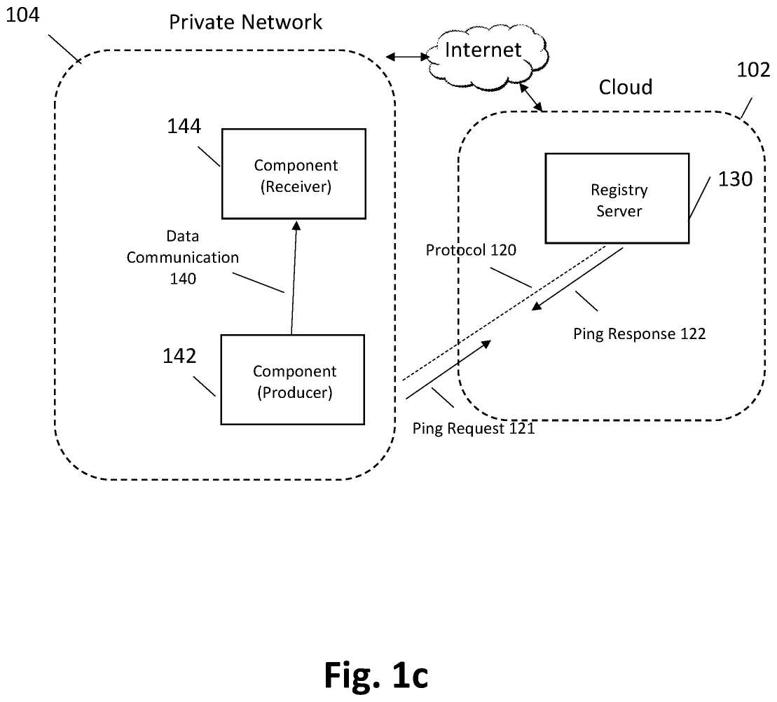

FIG. 1a through FIG. 1c present different environments with some variations. As one specific example, FIG. 1a illustrates a network architecture according to a particular embodiment where the organization decided to host all its components in the cloud 102. FIG. 1b illustrates a network architecture according to a second embodiment where the organization privileged a hybrid approach, where some of its components are located in the organization private network 104 and some in the cloud 102. FIG. 1c illustrates a third embodiment where all the components are in the organization private network 104. Moreover, the architecture of the components and/or interconnection between them may vary.

For all illustrated network architectures, the different locations—cloud 102, private networks 104—are interconnected by a network, referred to as the Internet in those examples.

FIG. 1a though FIG. 1c contain representative instances of components. Components can be any type of devices, as described in this disclosure, e.g., network devices, IoT devices or software components that may be parts of a 3-tier application composed of source devices, source aggregators, backends, databases, portals. However, as an example, in those three embodiments, the components are represented generically as a producer component 142 and a receiver component 144.

The central registry server 130 is in the cloud, publicly accessible at a specified domain name address.

The protocol 120 of the present invention depicts operations and communications on and among the shown components and the registry service. Specifically, protocol 120 presents a representative set of messages and operations that are used to indicate how to establish and maintain inter-connect communications between a component and its peer(s) over a lifecycle.

### System Architecture

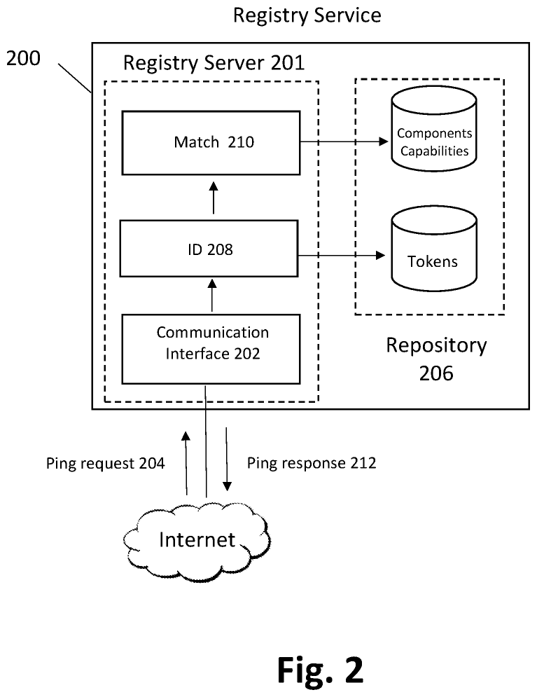

The registry service is illustrated in FIG. 2.

The role of the registry service 200 is to indicate how components must communicate with other components. The registry service operates based on the client-server model, through its communication interface 202. When a component contacts the registry service using a ping request 204, the component will give its potential connectivity information (if it can produce, receive, consume or supply a data stream). The registry server 201 will authenticate the component 208 using the tokens and will respond with a dynamic information, coming from the registry repository 206—later called repository—that is updated in near real-time with the information coming from other components. That repository is also updated by messages coming from users, and by the result of policies, e.g. expiration period, namespaces, etc.

Once authenticated 208, in response to the ping request, the registry service finds the peers 210, and returns a ping response 212 containing a list of none, one or multiple destination components to connect with, along with the connectivity characteristics so that the connections can be established between the peer components.

The registry service enables components to request connectivity information and other parameters automatically from everywhere, removing the need for an administrator or a user to configure it manually.

The registry service is designed to serve the entire network, meaning all registered components and tokens. Its design and its cloud implementation by default allow it to scale dynamically to support this growing number of requests.

The registry service is designed in such way that it can segregate information between different customers and organization as well as different environment for the same customer/organization.

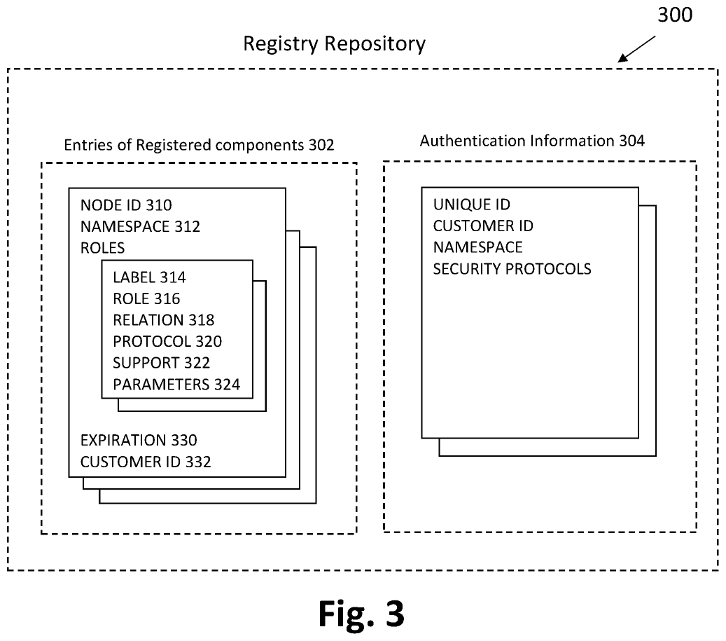

The registry repository is illustrated in FIG. 3.

The registry repository 300 contains a set of records for every registered component 302 and a set of records for every generated token 304.

The repository is continuously updated by every ping received from components, ensuring the data is near real-time and accurate. When a ping request is received, the registry server will either update the information or create a new entry in the repository for that component. An entry 302 consists of a set of attributes. An attribute has a name, a type and one or more values.

The repository is like a vault with stores fields and information in a secured and encrypted manner. The repository has no direct access to the credentials to be shared among components.

NODE ID 310 is the internal identifier of the component. The ID is unique across the registry repository.

NAMESPACE 312 is a value indicating the environment where the components belong. It is used to create a network of services, to implement multitenancy among the same owner of applications.

LABEL 314 is a mandatory text field where we specify the visual name of that component. It doesn't have to be unique, but it is a name which will help users identify this component visually, by example, when presented in a component inventory list. It also helps the component to classify peers in the ping response.

ROLE 316 is a value indicating the role of the component. That information will be used to build the relationships and interconnections between components. The protocol supports four roles producer, supplier, receiver, consumer. The producer role states that the component will produce data, supplier role.

A producer produces data of in a particular format. A producer's role is to push this data to an endpoint of a particular role, typically of a receiver.

A supplier makes data available to other components in a particular format. A supplier's role is to expose an endpoint of a particular role, typically used by a consumer.

A receiver receives data in a particular format. A receiver's role is to export an endpoint of particular role, typically used by a producer.

A consumer fetches data in a particular format. A consumer's role is to fetch data from an endpoint of a particular role, typically from a supplier.

RELATIONS 318 is a mandatory text field which explains the type of connectivity this element want to participate with. It will help the registry server know what other component can be candidate to connectivity with that component.

PROTOCOL 320 is a mandatory text field defining the expected protocol to be used within the connections that the registry server will assign to this component.

SUPPORT 322 is an optional list of text fields which can be used to specify what protocol version(s) are supported by this component.

PARAMETERS 324 is an optional list of attributes specific to the component domain like an URL endpoint or credentials.

EXPIRATION 330 is the time the entry should be stored in the registry repository. If no ping is received after a period of time, the expiration will eventually expire. When the expiration period is reached, the entry is deleted.

CUSTOMER ID 332 is the identifier of the organization. The CUSTOMER ID is unique across the registry repository.

The model is extensible and other attributes can be added, such as the telemetry attributes, providing, for example, information on the component health, stress and status

### Sequence of Operations

The following describes the typical sequence of operations of the present invention.

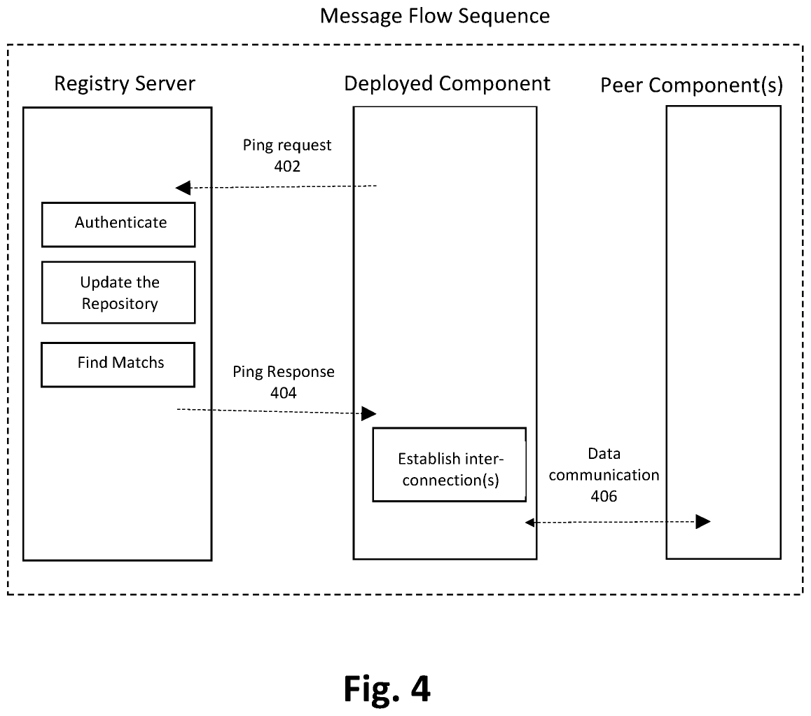

The sequence of operations is illustrated in FIG. 4.

A user registers to the registry service using a verified email address. Once authenticated, that user can create or join an organization. The user can then get or generate a token. That token is the only required complex string-text needed for a remote equipment, or a remote software component to get registered as a known component within that user organization. To do so, the component initiates a network connection to the central known registry service and sends a ping request message 402 with its token.

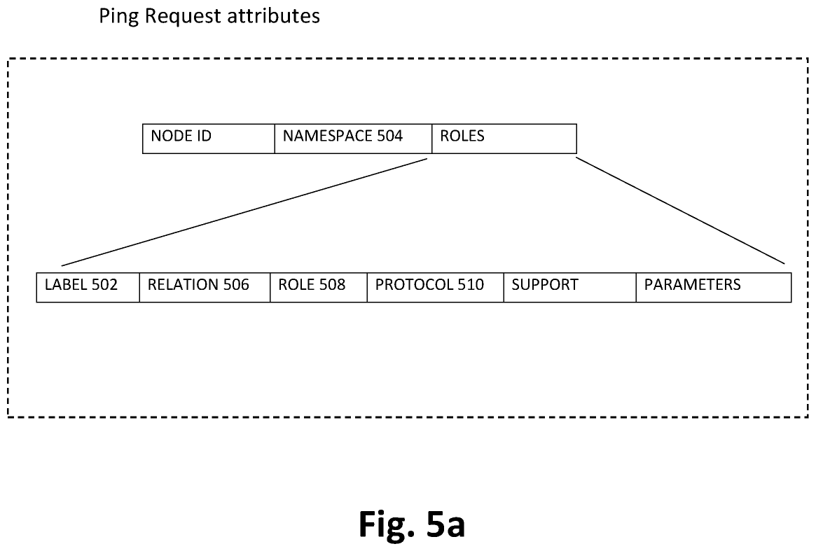

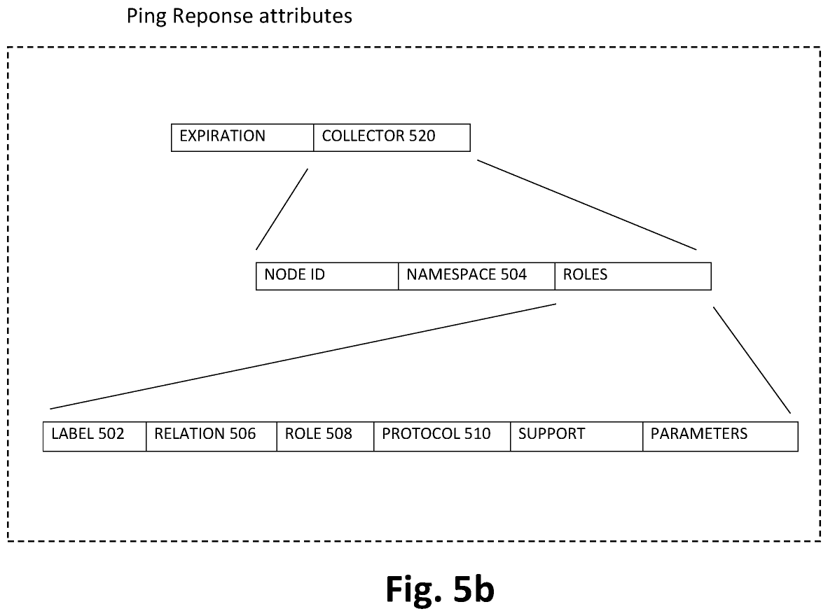

The ping request is illustrated in FIG. 5a.

The component typically generates the ping request at startup and periodically thereafter. The ping request serves multiple purposes. The main purpose of contacting the registry service, at the first time, is to determine which are the other components to connect with. The ping request indicates the component compatible connectivity information and characteristics, mainly but not only, its configured name called label 502, its configured group name also called namespace 504, its connectivity endpoints, relation 506 and role 508, protocols 510 and optionally the secured credentials to use when connecting to these endpoints. Also, if the component can connect to peers, it indicates what kind of protocol, authentication and network types it is compatible with. If the ping request is valid, the registry service will answer to the registering component using a ping response message. The message indicates it is successful, and, share the how and where to connect with compatible peer(s) if there are any. If the ping request is invalid, the registry server may indicate why.

The subsequent periodic ping requests ensure the connectivity information is still up-to-date. For every component, there is a default frequency, specified by the expiration attribute, for the ping request. If a registry service response is different from the previous ones, this will force the component to validate the connectivity information and apply that new connectivity configuration. In that case, the response will contain all the required information for the new connection(s). The response envelope, as above, provides a list of remote registered components to connect to, protocol, protocol version, credentials, and more if required.

Moreover, the ping request contains several health and stress statistics, so the registry service is informed in near real-time about the overall component state and can act in consequence. Finally, because the ping request is supposed to be sent at regular intervals, a non-response after an expiration time will be considered as unavailability, the registry service will then update its repository, and take actions based on policies.

If the registry service is unreachable or if the component doesn't receive a response from the registry service, the component will continue to operate with the last known information, so the data flow will not be impacted by a potential registry service downtime or network outage.

The ping response is illustrated in FIG. 5b.

The ping response will indicate the secure destinations for that component, in the Collector section 520. A component can have one, multiple or zero destinations. As an example, for the monitoring domain, the registry service will inform collectors modules where to push their data securely, inform backends where to connect to consume the data, inform portals on which databases to connect, and inform processing backends where to consume from.

At any time, the registry service can supply the list of registered components, their health, their stress, and on which peer components they communicate with. The registry service can also accept rules to update inter-connectivity. These rules are important; they are the business logic for user to tune the interconnections. It allows to reorder where and with who the components will interconnect.

### Technical and Business Considerations

By employing the systems and methods disclosed herein, increased security is provided, as the present invention forces every data transported to be encrypted.

The registry service can also act a validation authority to initiate the trust between the interconnected components and therefore secure and encrypt the communication between parties.

Furthermore, the registry service is not in the chain of service data communication, ensuring the data communication flows will not be impacted in case of a registry service downtime or network outage.

One major advantage of the present invention is that there is no configuration required on any module, which reduces the cost of discovering, creating and maintaining an interconnect network.

In addition, the light protocol makes it easy to add applications, devices, and any other components compatible with the present invention. Once done, those components can be deployed, connected, moved and controlled without configuration, thus ensuring maximum agility and automation. Users can create and launch new components if desired and modify the interconnections.

Also, the users, by querying the registry service repository, have full visibility on the global architecture, the list of all registered components, with their status, inter-connections, health, and usage.

Finally, the open nature of the present invention let users connecting any type of components, allowing them to build cross-domain services easily. As a general-purpose registry system, the invention can be used in multiple domains—enterprise applications, monitoring systems, IoT networks, etc.

What is claimed:

1. A method of enabling automatic connectivity between components over a communication network, and wherein the connectivity matching between components is controlled by a server device that determines the list of target components, said method comprising: receiving, using a network, a notification message from a requesting client component connected to the network, wherein the message comprises (i) an authentication token which identifies the namespace from which the requesting client component belongs to, and (ii) a set of information identifying attributes of the requesting client component; responsive to receiving the notification message, authenticating the requesting client component using the authentication token; based at least on a match between (i) said authentication token which uniquely identifies said namespace and (ii) information which identifies attributes of the requesting client component, determine a list of one, multiple or none client components associated with said requesting client component; transmitting, by the network, a response message to the requesting client component, said response message comprising (i) a list of client components to initiate network communication to, and (ii) connectivity parameters to use to initiate said network communication.

2. A registry server device in data communication via a network with a requesting client component, said registry server device configured to: receive request messages from said requesting client component over said network; store and maintain client component information in a repository; store and maintain a mapping between authentication tokens and namespaces in a repository; in response to said request messages, transmit a response message to the requesting client component.

3. The method of claim 1, wherein a namespace is associated with an authentication token.

4. The method of claim 1, wherein a client component is defined by a role attribute that is at least one of, “producer”, “supplier”, “receiver”, and “consumer”.

5. The method of claim 1, wherein a requesting client component initiates a request message at startup to the registry server device.

6. The method of claim 5, wherein a request message contains at least an authentication token and a set of attributes of the client component.

7. The method of claim 5, wherein a request message contains a set of statistics about the health and stress of the client component.

8. The method of claim 5, further comprising sending the request message periodically to the registry server device.

9. The method of claim 5, wherein a client component is considered unavailable if no request message is received after an expiration time.

10. The method of claim 2, wherein the registry server device maintains a mapping between the authentication token and a namespace

11. The method of claim 2, wherein the authentication token and roles of a client component are used to determine the list of candidate client components to which said client component should initiate connections with.

12. The method of claim 2, further comprising sending the list of candidate client components to which the requesting client component can connect to.

13. The method of claim 1, wherein the requesting client component initiates connectivity to a list of candidate client components, based on the response message coming from the registry server device.

14. The method of claim 2, wherein the response message sent by the registry server device to the client component includes at least the “protocol”, “protocol version”, “credentials” to use for connectivity to the remote client components.

15. The method of claim 2, wherein a response message from the register server device that is different from previous ones forces a client component to apply a new connectivity configuration.

16. The method of claim 2, wherein the registry server device stores information for each client components in a repository.

17. The method of claim 16, wherein the repository of the registry server device is updated in near real-time with requests messages received from client components.

18. The method of claim 16, wherein the repository of the registry server device stores at least health data and stress data reported by client components within the request message.

19. The method of claim 16, wherein the registry server device deletes information about a client component after an expiration period.
